(19) United States
(12) Patent Application Publication
(10) Pub. No.: US 2008/0283150 A1
(43) Pub. Date: Nov. 20, 2008

(54) Cutter insert for a tree stump milling cutter

(76) Inventors: Wolfgang Essig, Rosenfeld (DE); Thomas Wohrstein, Aichhalden (DE)

Correspondence Address: Pauley Petersen & Erickson, Suite 365, 2800 W. Higgins Road, Hoffman Estates, IL, 60169, US

(21) Appl. No.: 12/080,571

(22) Filed: Apr. 3, 2008

(30) Foreign Application Priority Data
Apr. 23, 2007 (DE) 102007019357.4-23

(51) Int. Cl. A01G 23/06

(52) U.S. Cl. 144/241; 299/111; 407/46

(57) ABSTRACT

A cutter insert for a tree stump milling cutter or the like with a milling tooth having a milling tooth head and a shaft. The shaft has two lateral faces extending in an advancement direction of the milling tooth, and the milling tooth head has a protrusion, which projects past the shaft in the advancement direction and has a support face. A high degree of operational dependability and service life result with such a cutter insert if the shaft has a neck projecting opposite the advancement direction, which is arranged at a distance from the support face of the protrusion.

### BACKGROUND OF THE INVENTION

1. Field of the Invention

This invention relates to a cutter insert for a tree stump milling cutter or the like with a milling tooth having a milling tooth head and a shaft, wherein the shaft has two lateral faces extending in an advancement direction of the milling tooth, and the milling tooth head has a protrusion which projects beyond the shaft in the advancement direction and has a support face.

2. Discussion of Related Art

A cutter insert is known from European Patent Reference EP 690 21 215 T2, wherein a cutter insert has a milling tooth with a milling tooth head and a shaft directly connected thereto. In cross section the shaft is approximately rectangular, so that it has two broad sides, which are parallel with each other. Through-shaped depressions are worked into the broad sides.

The milling tooth can be fastened laterally to a revolving disk by a holder. The holder has a slit for this purpose, which receives the shaft. The milling tooth is clampingly held against the shaft between the holder and the lateral face of the revolving disk. For fixing the shaft positively in place on the holder, the holder has a pin which engages the trough-shaped depression in the shaft. The milling tooth head is supported on a level support section of the holder. Forces generated during operational use are deflected from the milling tooth head into this support section. During operational use, this support surface wears out because of the shock-like stresses. The milling tooth then is tilted in the slit around a pivot axis formed by the combination of the trough-shaped depression and the pin. Then the operating forces are increasingly deflected via the shaft into the pin. The shaft, weakened by the trough-shaped depressions, can break or the pin can be sheared off.

### SUMMARY OF THE INVENTION

It is one object of this invention to provide a cutter insert of the type mentioned above but which has a long tool life and a high degree of operational dependability.

This object is attained if the shaft has a neck projecting opposite the advancement direction, which is arranged at a distance from the support face of the protrusion. With this arrangement the milling tooth is dependably fixed in place in a positive manner via the neck engaging the receptacle of the holder. In its not yet worn original position, the milling tooth is supported on the holder by its protrusion and/or neck. If now, because of wear, a reduction of the corresponding support sections of the holder occurs, the milling tooth still remains securely supported without the danger of a shaft break occurring.

The neck can provide a dependable and stable support location if the neck extends transversely with respect to the advancement position over the entire shaft width.

In one embodiment of this invention, the milling tooth head has a cutter insert made of a hard material, the cutter insert has a strip-like cutting edge which partially extends around a trough in the cutter insert, and the surface constituting or forming the trough is conducted, at least partially, into a draw-off face of the milling tooth.

A sharp cutting contour with low penetration resistance is obtained by the strip-like cutting edge. The cut-off chip can move away with little resistance through the trough and the draw-off area.

In order to dependably protect the shaft against breaking in the particularly stressed transition area between the shaft and the cutting tooth head, with this invention, in the front facing the advancement direction the milling tooth has an apron which widens the milling tooth head over the shaft in the advancement direction. This widened area extends in the longitudinal shaft direction at least partially over the area of spacing between the protrusion and the neck. In this case, the apron and the neck widen the shaft cross section.

In this connection, the draw-off area can extend over the apron in the front.

It is thus possible to achieve a particularly resistance-free chip flow because the draw-off face is created by a concave surface.

In another embodiment of this invention, the milling tooth head has a convex clear area opposite the advancement device.

A combination of a cutter insert and a holder is also part of this invention, wherein the holder has a slit in a base element, the cutter insert is inserted into the slit with its shaft, and the base element has a receptacle which the milling tooth engages with its neck. It is thus possible to achieve a tool layout optimized with respect to wear, because the draw-off face and/or the clear area of the milling tooth transitions into shaped areas of the holder.

### BRIEF DESCRIPTION OF THE DRAWINGS

This invention is explained in greater detail in view of an exemplary embodiment represented in the drawings, wherein:

FIG. 1 is a perspective exploded view of a milling tooth and a holder; and

FIG. 2 shows the arrangement in accordance with FIG. 1 but in an assembled representation and a lateral view.

### DETAILED DESCRIPTION OF THE INVENTION

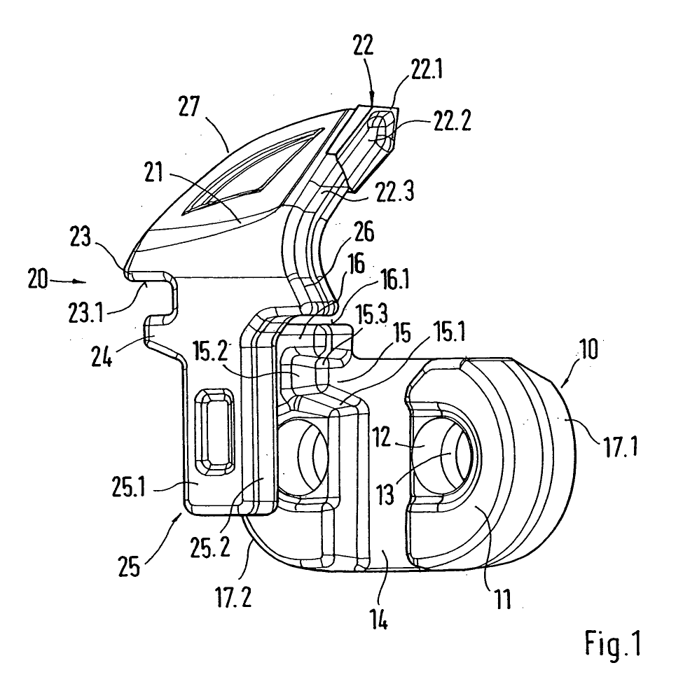

FIG. 1 shows a holder 10, having a base element 11 embodied or formed as a forged part. A slit 14 is cut into the base element 11. Screw receptacles 12, each designed as a through-bore, are respectively on both sides of the slit 14. The screw receptacles 12 are widened by a depression 13 at the front face of the holder 10 facing away from the drawing plane and are used for the recessed reception of the screw heads of fastening screws, which pass through the screw receptacles 12.

The base element 11 has a receptacle 15 following the slit 14. The receptacle 15 is delimited by a support face 15.1, a front face 15.2 and a cover side 15.3 and is cut in a direction opposite the tool advancement direction, from left to right in the drawing plane of FIG. 1.

In this case, the cover side 15.3 is constituted or formed by an attachment 16. On its top facing away from the cover side 15.3, the attachment 16 has a support section 16.1.

The holder 10 is used for fixing a milling tooth 20 in place. The milling tooth 20 has a milling tooth head 21, which is followed by a shaft 25. The milling tooth head 21 has a receptacle, into which a cutter element 22 of a hard metal is soldered. The cutter element 22 has a U-shaped, continuous, strip-like cutting edge 22.1 surrounding a trough 22.2. The trough 22.2 transitions into a front draw-off face 22.3 at the milling tooth head 21. The concave draw-off face 22.3 extends over an apron 26 located at the front and protruding past or beyond the shaft 25 in the advancement direction of the tool.

At the rear, the milling tooth head 21 has a concavely arched free area 27 following the cutter element 22.

The shaft 25 is delimited by two lateral faces 25.1, which extend parallel with respect to each other in the advancement direction and are connected with each other by transverse faces 25.2.

In the area of the rear transverse face 25.2, the neck 24 protrudes opposite the advancement direction. The neck 24 is spaced apart from a support surface 23.1 constituted or formed by a projection 23 protruding past or beyond the shaft 25. As shown in FIG. 1, the area of the space between the support surface 23.1 and the neck 24 is bridged by the apron 26, so that there is a cross-sectional widening.

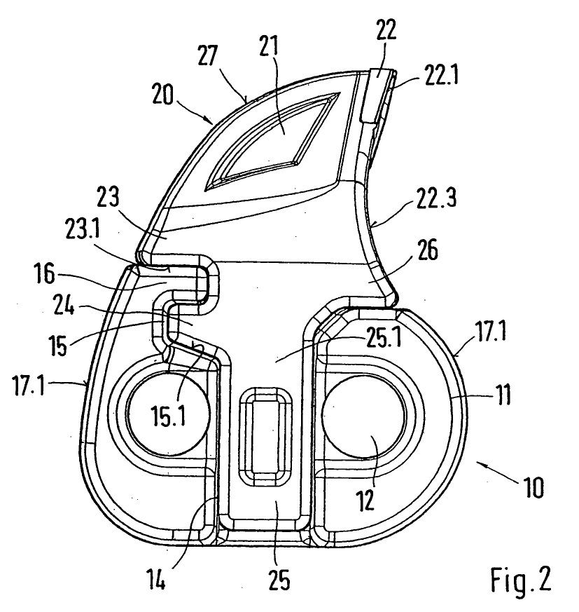

The milling tooth 20 can be introduced into the holder 10 so that the shaft 20 rests in the slit 14 and the neck 24 in the receptacle 15. With its support surface 23.1, the milling tooth 20 is supported on the support section 16.1 and/or with a neck 24 on the support face 15.1. In this case, and as shown in FIG. 2, the support surface 23.1 is placed directly on top of the support section 16.1, while the neck 24 is maintained with slight play in the receptacle 15.

If while being used the support section 16.1 wears off, the shoulder 24 rests on the support face 15.1, because of which there is an additional wear-reducing support.

As FIG. 2 shows, the free area 27 and the draw-off face 22.3 transition into the convexly shaped faces 17.1 of the holder 10, so that a tool geometry results which offers little wear-increasing resistance to the cut-off material.

German Patent Reference 10 2007 01 357.4-23, the priority document corresponding to this invention, and its teachings are incorporated, by reference, into this specification.

What is claimed is:

1. A cutter insert for a tree stump milling cutter or a similar cutter with a milling tooth (20) having a milling tooth head (21) and a shaft (25), wherein the shaft (25) has two lateral faces (25.1) extending in an advancement direction of the milling tooth (20), and the milling tooth head (21) has a protrusion (23) which projects beyond the shaft (25) in the advancement direction and has a support surface (23.1), the cutter insert comprising:
the shaft (25) having a neck (24) projecting opposite the advancement direction which is arranged at a distance from the support face (23.1) of the protrusion (23).

2. The cutter insert in accordance with claim 1, wherein the neck (24) extends transversely with respect to the advancement position over an entire shaft width.

3. The cutter insert in accordance with claim 2, wherein the milling tooth head (21) has a cutter insert (22) made of a hard material, the cutter insert (22) has a strip-like cutting edge (22.1) partially extending around a trough (22.2) in a cutter insert (22), and a surface forming the trough (22.2) is at least partially conducted into a draw-off face (22.3) of the milling tooth (20).

4. The cutter insert in accordance with claim 3, wherein in a front facing the advancement direction the milling tooth (20) has an apron (26) which widens the milling tooth head (21) over the shaft (25) in the advancement direction, and a widened area extends in a longitudinal shaft direction at least partially over an area of spacing between the protrusion (23) and the neck (24).

5. The cutter insert in accordance with claim 4, wherein the draw-off face (22.3) extends over the apron (26) in the front.

6. The cutter insert in accordance with claim 5, wherein the draw-off face (22.3) is formed by a concave surface.

7. The cutter insert in accordance with claim 6, wherein the milling tooth head (21) has a convex clear area (27) opposite the advancement device.

8. The cutter insert in accordance with claim 7, wherein there is a cutter insert-holder unit and a holder (10) which has a slit (14) in a base element (11), wherein the cutter insert is inserted into the slit (14) with a shaft (25), and the base element (11) has a receptacle (15), which the milling tooth (20) engages with a neck (24).

9. The cutter insert-holder unit in accordance with claim 8, wherein the draw-off face (22.3) and/or the clear area (27) of the milling tooth (20) transition into shaped areas (17.1, 17.2) of the holder (10).

10. The cutter insert in accordance with claim 1, wherein the milling tooth head (21) has a cutter insert (22) made of a hard material, the cutter insert (22) has a strip-like cutting edge (22.1) partially extending around a trough (22.2) in a cutter insert (22), and a surface forming the trough (22.2) is at least partially conducted into a draw-off face (22.3) of the milling tooth (20).

11. The cutter insert in accordance with claim 1, wherein in a front facing the advancement direction the milling tooth (20) has an apron (26) which widens the milling tooth head (21) over the shaft (25) in the advancement direction, and a widened area extends in a longitudinal shaft direction at least partially over an area of spacing between the protrusion (23) and the neck (24).

12. The cutter insert in accordance with claim 11, wherein the draw-off face (22.3) extends over the apron (26) in the front.

13. The cutter insert in accordance with claim 4, wherein the draw-off face (22.3) is formed by a concave surface.

14. The cutter insert in accordance with claim 1, wherein the milling tooth head (21) has a convex clear area (27) opposite the advancement device.

15. The cutter insert in accordance with claim 1, wherein there is a cutter insert-holder unit and a holder (10) which has a slit (14) in a base element (11), wherein the cutter insert is inserted into the slit (14) with a shaft (25), and the base element (11) has a receptacle (15), which the milling tooth (20) engages with a neck (24).

16. The cutter insert-holder unit in accordance with claim 15, wherein the draw-off face (22.3) and/or the clear area (27) of the milling tooth (20) transition into shaped areas (17.1, 17.2) of the holder (10).
